(19) United States
(12) Patent Application Publication
(10) Pub. No.: US 2008/0311266 A1
(43) Pub. Date: Dec. 18, 2008

(54) Salt Enhancement

(76) Inventors: Kimberley H. GRAY, Loveland, OH (US); Gregory Lee YEP, Cincinnati, OH (US); Robert G. Eilerman, Manhasset, NY (US)

Correspondence Address: CURATOLO SIDOTI CO., LPA, 24500 CENTER RIDGE ROAD, SUITE 280, CLEVELAND, OH, 44145, US

(21) Appl. No.: 12/134,411

(22) Filed: Jun. 6, 2008

Related U.S. Application Data
(60) Provisional application No. 60/933,357, filed on Jun. 6, 2007.

(51) Int. Cl. A23L 1/226

(52) U.S. Cl. 426/537

(57) ABSTRACT

A method of enhancing the perceived saltiness of an orally-ingestible composition, comprising the incorporation therein of a compound which is a cooling compound in a proportion that is below the cooling threshold but that provides a salt enhancement. Therefore, less salt is needed to provide, a desirable salty taste to foodstuffs, beverages and the like, and the products, are healthier as a result.

This application claims the benefit of the filing date of U.S. Provisional Application for Patent Ser. No. 60/933,357, filed Jun. 6, 2007.

This disclosure relates to a method of salt enhancement.

The enhancement of salt flavor in foodstuffs has become very important since the traditional method of salt enhancement (simply adding more salt) may have serious health consequences. As a result of this concern, there are now many salt-reduced products on the market, but many of these are regarded by consumers as lacking flavor. Something that enhances the perception of saltiness and therefore the flavor without actually using more salt is therefore highly desirable. Examples of salt enhancing compounds and compositions include proteolysed protein sources (EP 0 677 249) and L-aspartic acid/L-arginine blend (U.S. Pat. No. 5,176,934).

It has now been found that it is possible to enhance the flavour of compositions by the addition thereto of certain compounds. There is therefore provided a method of enhancing the perceived saltiness of an orally-ingestible composition, comprising the incorporation therein of a compound which is a cooling compound in a proportion that is below the cooling threshold but that provides a salt enhancement.

By “cooling compound” is meant a chemical compound that exerts a cooling effect on the skin or the mucous membranes of the body. These are common ingredients in foodstuffs, beverages, chewing gums, dentifrices, mouthwashes, medical products such as lotions, creams and salves, and personal care products. A substantial number of such compounds are known.

One example is known of such a compound being, used as a flavor enhancer. This may be found in International Application WO 99/07235, in which WS3, one of the most successful of the carboxamide cooling compounds, is used to enhance fruit flavors, particularly in chewing gum. However, there is no mention of salt enhancement and the proportions used are substantially higher than those of the present method. It is known that eutectic mixtures of certain cooling compounds can provide a salt enhancement, but it has not been previously disclosed that individual cooling compounds or simple mixtures thereof when used at a proportion lower than the minimum proportion at which they exert a cooling effect, enhance the perception of saltiness.

The cooling compounds that are useful may be selected from any such cooling compounds known to the art. Examples of suitable compounds include, but are not limited to, menthol, menthyl lactate, TK-10, WS3 and WS-23. Other examples of suitable compounds include those described in US published application 2006-0276667 and International publication WO 2007/019719, the disclosures of which are incorporated herein by reference.

It is possible and permissible to use a mixture of two or more of such compounds in the present method; this is encompassed by the use of the expression “a compound”.

The quantity of cooling compound required varies with the compound, but the salt enhancement is given at a proportion considerably lower than that proportion regarded as the minimum level for cooling effect. An appropriate level is easily found for any identified compound by routine experimentation. However, for most cooling compounds, as a general rule, the maximum level is about 0.05 ppm, particularly from about 0.001 to about 0.05 ppm. cooling compound in a composition whose salt perception is to be raised. These levels are appropriate for well-known and widely-commercialised cooling compounds such as menthol, menthyl lactate, TK-10, WS-3 and WS-23.

In addition, the following compounds are useful:

(1) Compounds of the formula I

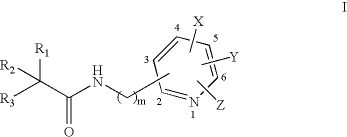

in which m is a number selected from 0, 1 and 2; X, Y and Z are selected independently from the group consisting of H, halogen, OH, Me, Et, MeO and EtO; and, R¹, R² and R³ together comprise at least 6 carbons, wherein
(a) (i) R¹ is selected from the group consisting of H, Me, Et, isopropyl and C₄-C₅ branched alkyl; and
   (ii) R² and R³ are independently selected from the group consisting of Me, Et, isopropyl and C₄-branched alkyl; or
(b) any two or all of R¹, R² and R³ together form a monocyclic, bicyclic or tricyclic radical having up to 10 carbons; and

(II) Compounds of the formula II

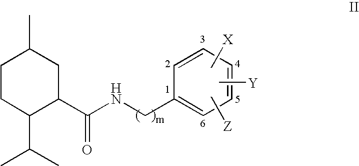

in which m is a number selected from 0, 1 and 2: Y and Z are selected independently from the group consisting of H, OH, C₁-C₄ straight or branched alkyl, or, a C₁-C₄ straight or branched alkoxy; X is (CH₂)ₙ—R, where n is 0 or 1 and R is a group with non-bonding electrons, with the provisos that:
(a) when Y and Z are H, X is not F, OH, MeO or NO₂ in the 4-position and is not OH in the 2 or 6-position
(b) when Y or Z is H then X, Y and Z are such that
   (i) the groups in the 3-and 4-positions are not both OMe,
   (ii) the groups in the 4-and 5-positions are not both OMe,
   (iii) the groups in 3-and 5-positions are not OMe if the group in the 4-position is OH, and
   (iv) the groups in the 3-and 5-positions are not OH if the group in the 4-position is methyl.

Useful groups wiih non-bonding; electrons are halogens, OH, OMe, NO₂, CN, Ac, S0₂NH₂, CHO, CO₂H and C₁-C₄ alkyl carboxylates such as CO₂Et. Other C₁-C₄ alkyl carboxylates with non-bonding electrons may be useful.

As used herein, Ac is acyl, Me is methyl, Et is ethyl, MeO and OMe are methoxy, and EtO is ethoxy.

Compounds of the formulae I and II and their preparation are described in the abovementioned US published application 2006-0276667 and International publication WO 2007/019719.

In a particularly surprising aspect, some compounds of the type described in the abovementioned US published application 2006-0276667 and International publication WO 2007/019719 have salt enhancement thresholds up to one order of magnitude lower than the known cooling compounds hereinabove described. Particular examples include N-(4-cyanomethylphenyl) p-menthanecarboxamide and N-(2-pyridin-2-ylethyl) p-menthanecarboxamide [(1R,2S,5R)-2-isopropyl-5-methyl-N-(2-(pyridin-2-yl)ethyl)cyclohexanecarboxamide]. In these cases, the upper threshold value for salt enhancement is 0.005 ppm, particularly from. 0.0001 to 0.005 ppm.

The following table shows examples of particular concentrations:

| | | Threshold level at |
|---|---|---|
| | Level at which | which cooling |
| | saltiness increase | effect detected |
| Compound | perceived (ppm) | (ppm) - estimated |
| Compound 1* | 0.005 | 0.08 |
| Compound 2** | 0.005 | 0.08 |
| WS3 | 0.05 | 1 |
| WS23 | 0.05 | 1.5 |
| Menthol | 0.05 | 1.5 |
| menthyl lactate | 0.05 | 0.8 |
| TK-10 | 0.005 | 0.8 |

*N-(4-cyanomethylphenyl) p-menthanecarboxamide
**N-(2-pyridin-2-ylethyl) p-menthanecarboxaimide [(1R.2S.5R)-2-isopropyl-5-methyl-N-(2-(pyridin-2-yl)ethyl)cyclohexanecarboxamide]

The compounds may be added to a composition by entirely conventional means. In such compositions, their presence raises substantially the perception of saltiness, thus allowing the actual salt content to be substantially reduced while maintaining taste and consumer acceptance.

The invention is further described with reference to the following non-limiting example.

### EXAMPLE

A variety of compounds (listed in the table above) was tested in a salt-reduced broth. The compounds concerned were simply added to samples of the broth in a variety of concentrations and stirred in. The samples were tested by their being submitted to a tasting panel, which recorded its perceptions as to which sample (and therefore at what level of compound) a perception of increased saltiness was observed. The results are recorded in the table in the specification above.

It can be seen that all of the compounds had an effect on the perceived saltiness, but Compounds 1 and 2 had a considerably greater effect.

Although the process and compounds have been described in detail through the above detailed description and the preceding example, these are for the purpose of illustration only and it is understood that variations and modifications can be made by one skilled in the art without departing from the spirit and the scope of the invention. It should be understood that the embodiments described above are not only in the alternative, but can be combined.

We claim:

1. A method of enhancing the perceived saltiness of an orally-ingestible composition, comprising the incorporation therein of a compound which is a cooling compound in a proportion that is below the cooling threshold but that provides a salt enhancement.

2. A method according to claim 1, in which the cooling compound is selected from the group consisting of menthol, menthyl lactate, TK-10, WS-3 and WS-23 and the following compounds:
(I) Compounds of the formula I 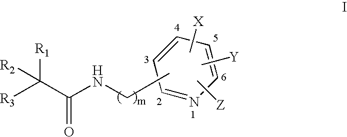
in which m is a number selected from 0, 1 and 2, X, Y and Z are selected independently from the group consisting of H, halogen, OH, Me, Et, MeO and EtO; and, R¹, R² and R³ together comprise at least 6 carbons, wherein
(a) (i) R¹ is selected from the group consisting of H, Me, Et, isopropyl and C₄-C₅ branched alkyl; and
(ii) R² and R³ are independently selecied from the group consisting of Me, Et, isopropyl and C₄-branched alkyl; or
(b) any two or all of R¹, R² and R³ together form a monocyclic, bicyclic or tricyclic radical having up to 10 carbons; and
(II) Compounds of the formula II 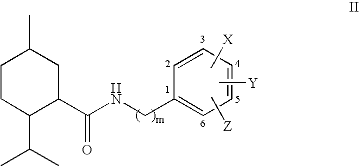
in which m is a number selected from 0, 1, and 2; Y and Z are selected independently from the group consisting of H, OH, C₁-C₄ straight or branched alkyl, or, a C₁-C₄ straight or branched alkoxy; X is (CH₂)ₙ—R, where n is 0 or 1 and R is a group with non-bonding electrons, with the provisos that:
(a) when Y and Z are H, X is not F, OH, MeO or N0₂ in the 4-position and is not OH in the 2 or 6-position
(b) when Y or Z is H then X, Y and Z are such that
(i) the groups in the 3- and 4-positions are not both OMe,
(ii) the groups in the 4- and 5 -posiiions are not both OMe,
(iii) the groups in 3-and 5-posilions are not OMe if the group in the 4-position is OH, and
(iv) the groups in the 3- and 5-positions are not OH if the group in the 4-position is methyl.

3. A method according to claim 2, in which the cooling compound is used at a concentration of up to about 0.05 ppm maximum of the composition.

4. A method according to claim 3, in which the concentration is from about 0.001 ppm to about 0.05 ppm.

5. A method according to claim 2, in which the compound is selected from at least one of N-(4-cyanomethylpheny) p-menthanecarboxamide and N-(2-pyridin-2-ylethyl) p-menthanecarboxamide [(1R,2S,5R)-2-isopropyl-5-methyl-N-(2-(pyridin-2-yl)ethyl)cyclohexanecarboxamide] and is used at a concentration of up to about 0.005 ppm maximum.

6. A method according to claim 5, in which the concentration is from about 0.0001 ppm to about 0.005 ppm.

7. A method according to claim 2, in which R is selected from the group consisting of halogens, OH, OMe, NO₂, CN, Ac, SO₂NH₂ , CHO, CO₂H and C₁-C₄ alkyl carboxylates.
